(19) United States
(12) Patent Application Publication
(10) Pub. No.: US 2004/0005269 A1
(43) Pub. Date: Jan. 8, 2004

(54) Method for selectively producing carbon nanostructures

(76) Inventors: Houjin Huang, Kanagawa (JP); Hisashi Kajiura, Kanagawa (JP); Masafumi Ata, Kanagawa (JP)

Correspondence Address: FROMMER LAWRENCE & HAUG LLP, 745 FIFTH AVENUE, NEW YORK, NY, 10151, US

(21) Appl. No.: 10/437,512

(22) Filed: May 14, 2003

Related U.S. Application Data
(60) Provisional application No. 60/386,341, filed on Jun. 6, 2002.

(51) Int. Cl. D01F 9/12; B01J 8/04

(52) U.S. Cl. 423/447.3; 422/198; 422/190

(57) ABSTRACT

A method for producing carbon nanostructures using a chemical vapor deposition process. A carbon source and a mixture catalyst are used wherein the mixture catalyst includes at least one element, from a group A including Fe, Co and Ni, and at least one supporting element, from a group B including lanthanides. The lanthanide elements can be used to lower the melting point of the catalyst by forming alloys so that the carbon nanostructures can be grown at lower temperatures. Further, the lanthanide elements also enhance catalyst activity of Ni, Co or Fe by changing the catalyst surface electronic properties. Also, the lanthanide elements also scavenger excess carbon so that carbon nanostructures can be grown without contamination.

### BACKGROUND OF THE INVENTION

1. Field of the Invention

The present invention relates to methods for producing high purity carbon nanostructures, including multi-walled carbon nanotubes and single-walled carbon nanotubes. More particularly, the present invention relates to methods for producing high-purity carbon nanostructures by using lanthanides as a part of a catalyst for chemical vapor deposition production of the carbon nanostructures.

2. Description of the Related Art

In the related art, almost at the same time period of the advent of electron microscopy in the 1970's, carbon fibril materials have been found and identified as materials of interest for a variety of applications. These carbon fibrils are carbon deposits produced by catalytical chemical vapor deposition (CCVD). The diameters of these carbon fibrils are less than approximately 1.0 micrometer.

The existence of multi-walled carbon nanotubes in the CCVD deposit was described for the first time in 1984 (Tennent, U.S. Pat. No. 4,663,230). Early surveys can be found in Baker and Harris, Chemistry and Physics of Carbon, Walker and Thrower ed., Vol. 14, 1978, p. 83, and in Rodriguez, N., J. Mater. Research, Vol. 8, p. 3233 (1993).

Multi-walled carbon nanotubes of morphology similar to the catalytically grown carbon fibrils have also been grown in a high temperature carbon arc (Iijima, Nature 354, 56, 1991). It is now generally accepted (Weaver, Science 265, 1994) that these arc-grown nanofibers have the same morphology as the earlier catalytically grown fibrils of Tennent (U.S. Pat. No. 4,663,230, and U.S. Pat. No. 5,171,560). These carbon nanotubes are cylindrical, non-separated cavities surrounded with graphitic layers substantially parallel to the fibril axis.

Bamboo-shaped multiwalled carbon nanotubes, in which graphene layers separate the central cavities, were found in arc discharge soot in 1993 (Saito, J. Crystal Growth, 134, 154, 1993; Saito, Carbon, 979, 1995). Recently several research groups using CCVD methods have prepared these carbon nanotubes (Lee et al., Chem. Phys. Letts., 323, 560, 2000; Zhang et al., Chem., Phys. Letts., 333, 509, 2001). A yield of CNTs (that is, catalytic productivity defined as the weight ratio of CNTs vs. catalyst) as high as 600% has been achieved (Li et al., Appl. Phys. A, 73, 259, 2001).

Single-Walled Carbon Nanotubes (SWNT's)

Iijima and Bethune independently found single-walled nanotubes, i.e., nanotubes having only a single layer of carbon arranged in the form of a linear fullerene, from arc discharge soot in 1993 (see, Iijima, S., “Single-shell carbon nanotubes of 1-nm diameter”, Nature, 363, 603, 1993; Bethune et al., “Cobalt-catalysed growth of carbon nanotubes with singe-atomic-layer walls”, Nature, 363, 605, 1993). U.S. Pat. No. 5,424,054 to Bethune et al. describes a process for producing single-walled carbon nanotubes by contacting carbon vapor with a cobalt catalyst using electric arc heating of solid carbon. Other techniques of carbon heating have been used, for instance, laser heating, electron beam heating, and RF induction heating.

Smalley (Guo, T., Nikoleev, P., Thess, A., Colbert, D. T., and Smally, R. E., Chem. Phys. Lett. 243: 1-12 (1995); Thess, A., Lee, R., Nikolaev, P., Dai, H., Petit, P., Robert, J., Xu, C., Lee, Y. H., Kim, S. G., Rinzler, A. G., Colbert, D. T., Scuseria, G. E., Tonarek, D., Fischer, J. E., and Smalley, R. E., Science, 273: 483-487 (1996)) developed a method of producing single-walled carbon nanotubes wherein graphite rods and a transition metal are simultaneously vaporized by a laser in an oven at about 1200° C. Single-wall nanotubes were reported to be produced in yields of more than 70%.

Each of these techniques described above employ solid carbon as the carbon feedstock. These techniques are inherently disadvantageous. Specifically, solid carbon vaporization via electric arc or laser apparatus is costly and difficult to operate on the commercial or industrial scale.

A chemical vapor deposition (CVD) process with metal catalysts that are put on a fixed CVD bed for SWNT formation is also known. Smalley (Dai., H., Rinzler, A. G., Nikolaev, P., Thess, A., Colbert, D. T., and Smalley, R. E., Chem. Phys. Lett. 260: 471-475 (1996)) describes supported Co, Ni and Mo catalysts for growth of both multi-walled nanotubes and single-walled nanotubes from carbon monoxide, and a proposed mechanism for their formation. Syntheses of SWNTs are improved using Fe/Mo or Co/Mo binary catalysts supported on still silica or alumina materials. (see, Cassell et al., J. Phys. Chem. B, 103, 6484, 1999; Tang et al., Chem. Phys. Letts. 350, 19, 2001). However, supported metal catalysts are inherently disadvantageous, as the support is necessarily incorporated into the single-walled carbon nanotube formed therefrom. Moreover, when using the fix-bed catalyst method, it is difficult to control the structure of the carbon nanotubes. The catalyst productivity is usually low (<200%) due to the aggregation of the catalyst, and thus, the process is hard to be scaled up.

Floating catalyst methods have also been reported recently. Smalley et al. introduces high pressured catalyst precursor gas Fe(CO)₅ and a carbon source CO into a thermal reactor. SWNTs (so called HiPco SWNTs) are generated at high temperature (1000° C.) (see, Smalley R. E. WO 00/26/26138). The advantage of this method is that SWNTs can be continuously produced. However, the high-pressure (>30 atm.) and high-temperature process used for this method imposes a great challenge for a safe and large-scale production of carbon nanotubes.

### SUMMARY OF THE INVENTION

An object of the invention is to provide methods for producing high-purity carbon nanostructures that are efficient and operable to be scaled up.

Another object of the invention is to provide an optimized combination of catalysts for efficient growth of carbon nanostructures.

It is a further object to provide a method to prepare this optimized combination of catalysts on a nanometer scale.

It is still another object to prevent catalysts from severe agglomeration during a thermal chemical vapor deposition process to promote high catalyst productivity.

In order to achieve these objects, one feature of the invention is the use of lanthanides as part of a catalyst composition in a thermal chemical vapor deposition process. More specifically, these objects are accomplished by a method for producing carbon nanostructures comprising:

chemical vapor deposition, in a thermal environment, using a carbon source and a mixture catalyst, the mixture catalyst comprising at least one element, from a group A including Fe, Co and Ni, and at least one supporting element, from a group B including lanthanides.

In the invention, the Fe, Co and Ni may be in their metallic, oxide, or alloy form. Also, the lanthanides may include, in particular, Ce, Pr, Nd, Sm, Eu, Gd, Tb, Dy, Ho, Er, Tm, Yb, and Lu. The lanthanides may be in their oxide or alloy form.

In order to make the catalyst mixture as uniform as possible, the catalyst mixture, with or without supporters, may be subjected to ball milling using milling techniques familiar to those of ordinary skill in the art. The inventors have found that ball-milled catalysts allow for higher catalyst productivity of the carbon nanostructures. This feature of the invention is particularly useful for growing single-walled carbon nanotubes using the method of the invention.

In another embodiment of the invention, the nano-sized catalysts are introduced into the reaction zone of a thermal environment, such as that which can be created by a thermal reactor, together with the carbon sources. This method of introducing the catalysts into the reaction zone helps to prevent severe agglomeration of the milled catalyst so that the catalyst productivity can be further enhanced. For introducing the catalyst into the reaction zone, the solid catalysts can be, for example, carried with carrier gases or sprayed with a pressured nozzle.

An apparatus that can be used in producing carbon nanostructures and also for performing the method of the invention is also disclosed herein. The apparatus, in one embodiment, includes a catalyst supplier for supplying a catalyst into the thermal reactor and a carbon source supplier for providing a carbon source. The catalyst supplier is located external to the thermal reactor and allows for introducing catalytic powder into the thermal reactor as a solid phase by gas flowing.

The above and other objects and advantages of the present invention will become more apparent by describing in detail preferred embodiments thereof with reference to the accompanying drawings.

### BRIEF DESCRIPTION OF THE DRAWINGS

FIG. 1 is a schematic drawing of a horizontal type apparatus of the invention used for producing carbon nanotubes.

FIG. 2 is a schematic drawing of a vertical type apparatus used for producing carbon nanotubes

FIGS. 3A and 3B are SEM images of multi-walled carbon nanotubes produced according to the method of the invention.

FIGS. 4A and 4B are TEM images of multiwalled carbon nanotubes.

FIG. 5 is thermo-gravimetric analysis of multiwalled carbon nanotubes.

FIG. 6 is a schematic cross-sectional view, taken along the direction perpendicular to the tube axis, of the tip of a carbon nanotube.

FIG. 7 is a schematic cross-sectional view, taken along the direction parallel to the tube axis, of the tip of a carbon nanotube.

FIG. 8 is a schematic perspective view of the tip of a carbon nanotube.

### DETAILED DESCRIPTION OF THE INVENTION

In the method of the invention, lanthanide elements are used as one of the effective catalytic components in a chemical vapor deposition process to produce carbon nanostructures. Incidentally, the method of the invention can be used to produce a variety of carbon nanostructures such as single-walled nanotubes (SWNT's), multi-walled nanotubes (MWNT's), MWNT's that include essentially bamboo-shaped carbon nanotubes with sharp tips, etc. As such, the term “nanostructure” is used to broadly refer to SWNT's, MWNT's, and the like that can be produced by the method of the invention.

In general, one reason that lanthanide elements such as Ce, Pr, Nd, Sm, Eu, Gd, Tb, Dy, Ho, Er, Tm, Yb, and Lu are used in the method of the invention is because they have rich physical and chemical properties due to their unfilled 4f electrons. At the temperature for carbon nanostructure growth as discussed below in further detail, lanthanide elements and compounds produced by the lanthanide elements can play multifunctional roles.

In particular, the inventors have found that lanthanide elements lower the melting point of the catalyst by forming alloys so that the carbon nanostructures can be grown at lower temperatures. This is important, for example, in producing high purity carbon nanostructures because carbon source materials, such as hexane, will dissociate quickly at high temperatures (>700° C.) so that carbon may be deposited too fast to form carbon nanostructures. Also at such high temperatures, the active nano-sized catalysts may lose their activity once they aggregate.

Next, the lanthanide elements also enhance catalyst activity of Ni, Co or Fe by changing their catalyst surface electronic properties. Ni, Co, Fe elements may be used in the method of the invention in their metallic, oxide, or alloy form.

The lanthanide elements also scavenger excess carbon so that carbon nanostructures can be grown without contamination.

In another embodiment of the method of the invention, small size catalysts are used in the chemical vapor deposition process. In this case, the inventors have found that the size of the catalyst can be very important with respect to carbon nanostructure growth. More specifically, the smaller the catalyst particles, the better the performance in growth of the carbon nanostructures. Small particles, especially nano-sized particles, are easily aggregate at elevated temperature. Accordingly, the introduction of the catalysts together with a carbon source has shown to be very effective in the production of carbon nanostructures.

In any embodiment of the method of the invention, the catalysts may be ball-milled using milling techniques known in the art to form nano-sized particles. More specifically, the particle sizes of the catalyst that are effective in producing carbon nanostructures include particles sizes of 10 micrometers or less, preferably 100 nm or less, and more preferably 10 nm or less.

In addition, the catalysts may be carried on nano-sized supporters, such as, for example, MgO or γ-alumina.

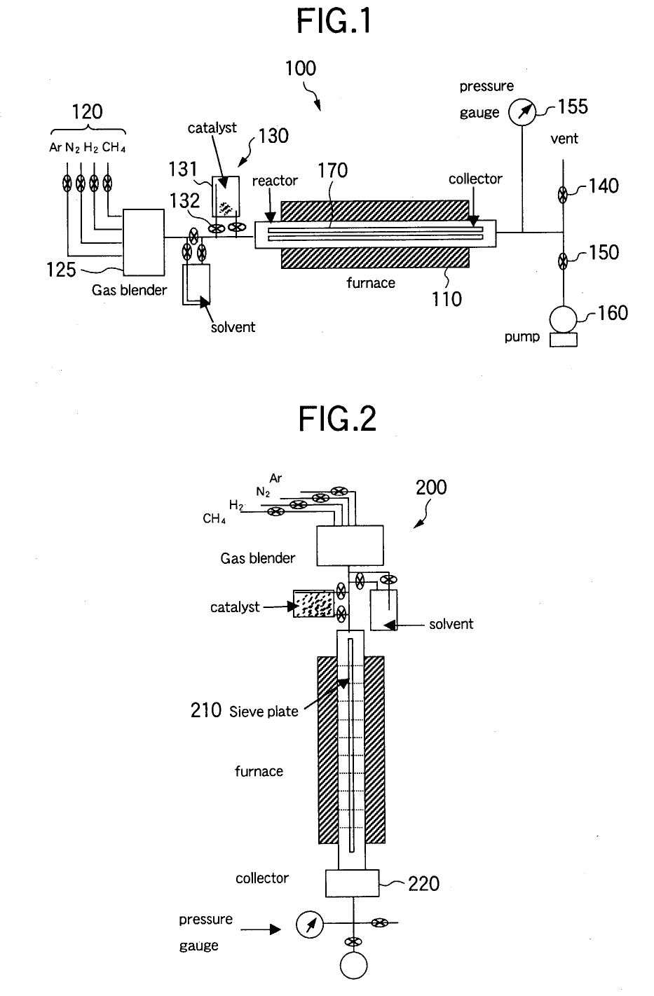

FIG. 1 depicts a schematic drawing of a horizontal type apparatus 100 that can be used in the method of the invention for carbon nanostructure production. As shown in FIG. 1, the thermal environment used for the chemical vapor deposition process may be created by use of a thermal (furnace) reactor 110. One example of a furnace reactor 110 that may be used in the invention is a three-zone mutual-regulated furnace with a temperature precision feature for regulating the temperature within ±2 degrees.

The production of carbon nanostructures using the method of the invention such as MWNTs or SWNTs, their structure and composition are largely decided by selection of the produced conditions during the chemical vapor deposition. In the method of the invention, the temperature used for chemical vapor deposition using the furnace reactor 110 may be fixed to a temperature in a range of 400° C. to 1200° C., and preferably in a range of 400° C. to 800° C. The gas pressure in the furnace reactor 110 can be set to be at ambient pressure by opening the vent valve 140, or set to be at a pressure below 1 atm. by adjusting a feedback valve 150 to a pump 160. The pressure of the apparatus may be measured by a pressure gauge 155 disposed upstream of the vent valve 140.

A carbon source supplier 120 is used to supply the carbon source, which, along with the mixture catalyst containing lanthanides, is used in the chemical vapor deposition process. The carbon source used in the method of the invention may be a hydrocarbon with a general formula CnHm, where n is in a range of 1 to 8 and m is in a range of 2 to 20. The carbon source may also be supplied in other carbon-containing organics, such as CH₂CH₂, CHCH, or liquid such as benzene and hexane, etc. Non-limiting examples of carbon nanostructures produced using hexane as the carbon source are described below.

The gases used, as shown in FIG. 1, include Ar, N₂, CH₄, and H₂. These gases are subjected to a gas blender 125, which is used to regulate the ratio and flow rate of the gases.

A catalyst supplier 130 includes a catalyst container 131, a catalyst supplier regulator 132, and pipes (not shown). In this configuration, the catalyst can be introduced into the furnace reactor 110 during the chemical vapor deposition process. Of course, the catalyst may instead, or in addition to being introduced into the furnace reactor 110 during the chemical vapor deposition process, be placed inside the furnace reactor 110 using ceramic tubes 170 prior to the chemical vapor deposition process.

The catalyst comprises at least one element, from a group A including Fe, Co and Ni, and at least one supporting element, from a group B including lanthanides. Group A can further include the Group VI-VIII metals and in particular, Ru, Rh, Pd, Os, Ir, Pt, and mixtures thereof. Also, Group B, in addition to the lanthanides, can include Sc, Y, and La elements.

The catalyst may be either in a pure form or supported on MgO or γ-alumina.

When preparing the catalyst, an atomic ratio of group A to group B in a range of 1:1000 to 1:1 can be used, and preferably, an atomic ratio in a range of 1:100 to 1:1.

As noted, in order to make the catalyst mixture as uniform as possible, the catalyst mixture, with or without supporters, may be subjected to ball milling using milling techniques familiar to those of ordinary skill in the art. The ball-milled catalysts allow for higher productivity of the carbon nanostructures. In the method of the invention, the particle sizes for either or both of group A and group B may be 10 micrometers or less, preferably 100 nm or less, and more preferably 10 nm or less.

After chemical vapor deposition, the nanostructure deposit is collected from the ceramic tubes 170 set inside the furnace.

A second embodiment of an apparatus that can be employed for the method of the invention is shown in FIG. 2. The basic components of this vertical-type apparatus 200 that are the same as those in FIG. 1 will not be explained. The vertical layout of the apparatus, however, makes the introduction of catalysts and the product collection more convenient. In this vertical apparatus as shown in FIG. 2, several reaction or sieve plates 210 may be placed inside the furnace to increase the retention time of the catalysts so that catalytic productivity can be improved. These reaction plates 210 can be designed to encompass many different shapes. A product collector 220 is set on the bottom of the furnace to collect the nanostructure deposit.

In order to facilitate a more complete understanding of the method of invention, the following non-limiting examples are provided.

### EXAMPLE 1

### Production of Bamboo-Shaped Carbon Nanotubes Using Lanthanide-Containing Catalysts and a Fixed-Bed

In a first example, a catalyst was prepared that included CeO₂ and NiO with an atomic ratio of 5:1. The catalyst was ball-milled at 400 rpm for 4 hours.

Using an apparatus, such as depicted in FIG. 1, 30 mg of the catalyst was then uniformly placed on the inside wall of ceramic tubes 170. Subsequently, the ceramic tubes 170 were installed inside of the furnace reactor 110 prior to the start of chemical vapor deposition.

A carbon source of hexane was used with a carrier gas of pure Ar. During operation of the apparatus, the flow rate of the carrier gas (Ar) was set at 100 c.c. per minute and the operating pressure was maintained at 1 atm. with a temperature inside of the furnace reactor 110 set at 680° C. The apparatus was run for 4 hours.

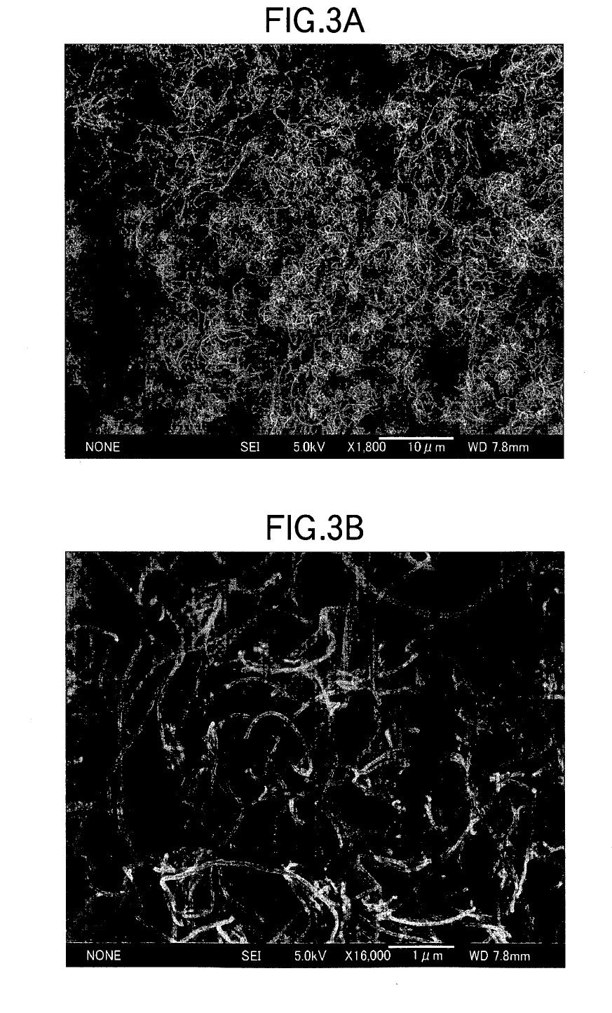

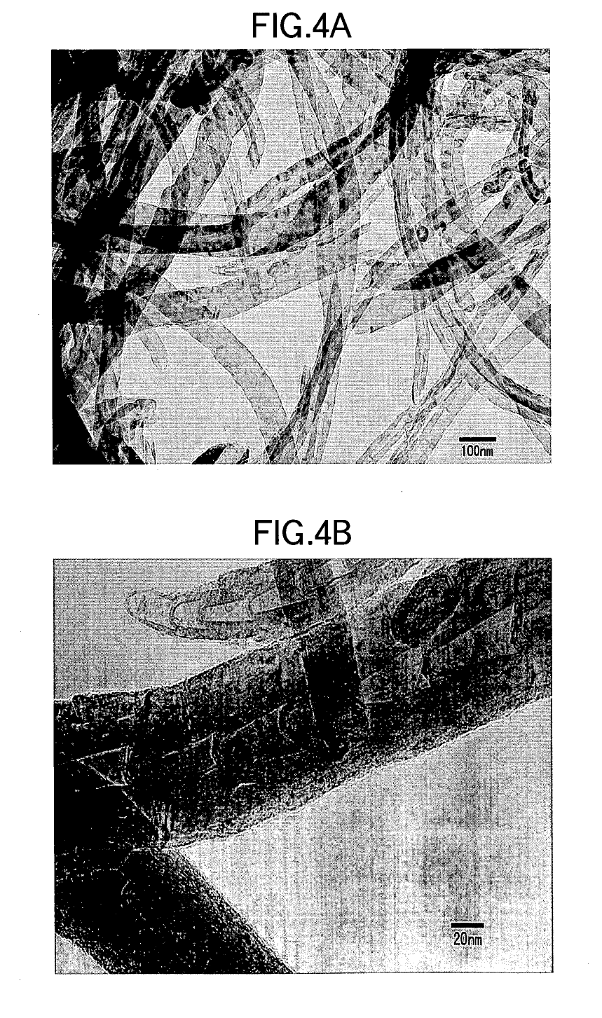

Based on this operation, 3.0 grams of material was collected from the ceramic tubes 170. Scanning Electron Microscope (SEM) and Transmission Electron Microscope (TEM) surveys of this material showed that the material primarily was comprised of MWNTs, as shown in FIGS. 3A and 3B and FIGS. 4A and 4B. The diameter of the MWNTs shown in these Figures is in the order of about 50 nm. Sharp tips of the MWNTs were frequently seen during examination.

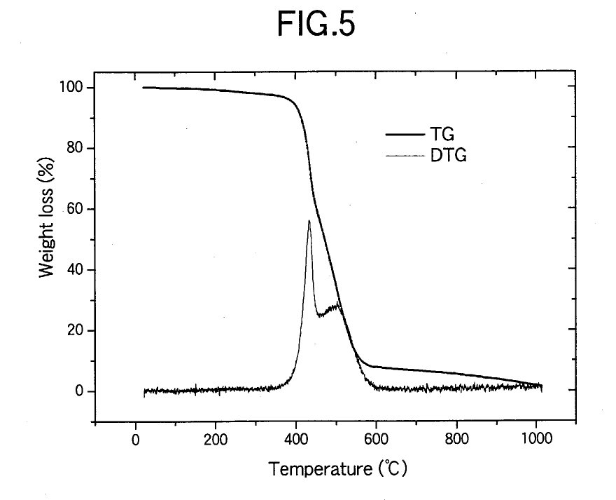

As shown in FIG. 5, a thermo-gravimetric analysis (TGA) measurement showed that this material contained about 1.0% weight of impurities that were not carbon. Accordingly, the catalytic productivity using the method of the invention in this particular example was is in the range of 5000-10000%, much higher than any other related art method.

### EXAMPLE 2

### Production of MWNTs Using Lanthanide-Containing and Flowing Catalysts

In a second example, a catalyst including La₂O3 and Ni powder was prepared in an atomic ratio of 5:1. The catalyst was ball-milled at 400 rpm for 10 hours and then placed in the catalyst container 131 as shown in FIG. 1 and carried by the flowing gas into the furnace reactor 110.

The carbon source used was hexane and the carrier gas used was pure Ar. During operation of the apparatus, the flow rate of the carrier gas (Ar) was set at 300 c.c. per minute and the operating pressure was maintained at 1 atm. with a temperature inside of the furnace reactor set at 680° C. The apparatus was run for 1 hour.

In this second example, 600 mg of material was collected from the ceramic tubes 170. SEM measurement showed that the material comprised mainly MWNTs with diameters around 40 nm. The purity of the materials was over 90% estimated from SEM surveys.

### EXAMPLE 3

### Production of MWNTs Using Lanthanide-Containing Supported Flowing Catalysts

In a third example of the invention, a catalyst was used that included a mixture of CeO₂, NiO, and MgO in an atomic ratio of 5:1:5. The catalyst was ball-milled at 400 rpm for 10 hours and put in the catalyst container 131.

The carrier gas used in the third example was Ar and H₂ with a ratio of Ar to H₂ of 3:1. The carbon source used was hexane. During operation of the apparatus, the flow rate of the carrier gas was set at 100 c.c. per minute and the operating pressure was maintained at 1 atm. with a temperature inside of the furnace reactor set at 680° C. The apparatus was run for 2 hours.

In this third example, 1.5 g of material was collected from the ceramic tubes 170. SEM measurement showed that the material contained mainly MWNTs with diameters around 20 nm. The purity of the material was over 90% estimated from SEM surveys.

### EXAMPLE 4

### Production of SWNTs Using Lanthanide-Containing Supported Flowing Catalysts

In a fourth example, the catalyst used was CeO₂, NiO and MgO with an atomic ratio of 10:1:10. This mixture was subjected to ball-milling at 400 rpm for 10 hours. The catalyst was then placed in the catalyst container 131.

The gases used were CH₄ and H₂ in a ratio of 1:4 which were passed through the gas blender 125 and then followed by passing through the catalyst container 131.

During operation of the apparatus, the flow rate of the gases was set at 100 c.c. per minute and the operating pressure was set at 600 torr. with a temperature inside of the furnace reactor set at 780° C. The apparatus was run for 1 hour.

The fourth example resulted in 55 mg of material being collected. SEM and TEM surveys showed that the materials contain mainly SWNTs with a purity over 70%.

As shown in these non-limiting examples and in other tests by the inventors, the method of the invention can be used to produce high purity carbon nanostructures, including multi-walled carbon nanotubes and single-walled carbon nanotubes.

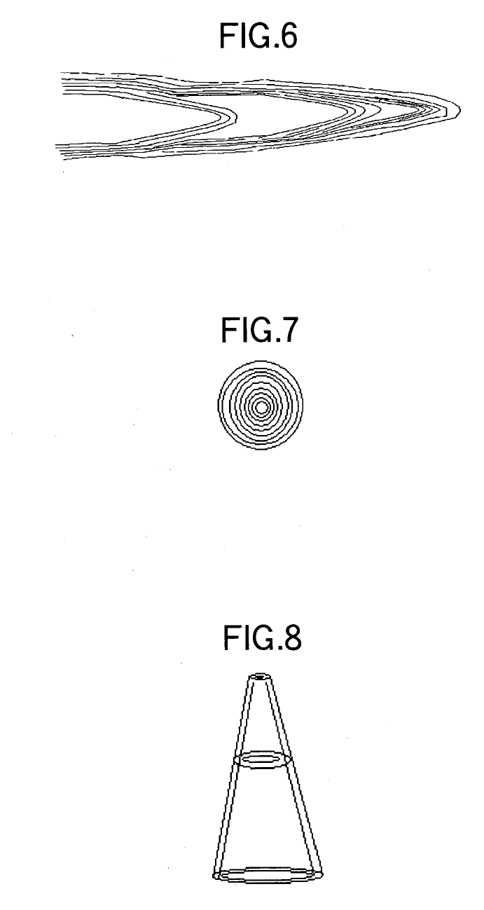

Of interest is that the method of the invention can produce essentially bamboo-shaped carbon nanotubes with sharp tips. These nanotubes have many separated compartments. FIGS. 6-8 are schematic drawings of bamboo-shaped carbon nanotubes produced by the method of the invention. FIG. 6 is a schematic cross-sectional view, taken along the direction perpendicular to the tube axis, of the tip of a carbon nanotube; FIG. 7 is a schematic cross-sectional view, taken along the direction parallel to the tube axis, of the tip of a carbon nanotube; and FIG. 8 is a schematic perspective view of the tip of a carbon nanotube.

The diameter of the bamboo-shaped carbon nanotubes produced by the method of the invention was is in the range of 5-100 nm. The tips of the carbon nanotubes was usually below 10 nm. The interlayer, or graphene layer distance inside the nanotubes was in the range of 0.34-0.68 nm.

The separated compartments of MWNT's produced by the method of the invention have diameters between 1 to 50 nm and a length of between 1 to 200 nm. A wall thickness for separating the compartments is between 0.3 to 3 nm.

The composition of nanostructures produced by the method of the invention can contain greater than 95% of MWNT. The preferred products produced by the method of the invention comprise greater than 99% MWNTs. As a note, these percentages are on weight basis.

The compositions, as produced, are extremely clean and can be used directly for most applications, including in use of field emitter displays that use carbon nanotubes. If necessary for the application, a minor work of purification can be carried out in a subsequent process to the method of the invention.

One of the most beneficial features of the method of the present invention is the continuous production of single-walled carbon nanotubes using a flowing solid catalyst, which ensures the possibility of mass production of tailored nanotube structures without the safety risk associated in other related art methods. The diameter of the SWNTs can be varied using the method of the invention from 1 nm to 5 nm according to different synthesis conditions. The composition can contain greater than 50% of SWNTs. Preferred products produced according to the invention may comprise greater than 90% SWNTs.

As noted, the production of MWNTs or SWNTs, their structure and composition are largely decided by selection of the produced conditions during the chemical vapor deposition and using the lanthanides as part of the catalyst mixture.

The present invention is not limited to the specific above-described embodiments. It is contemplated that numerous modifications may be made to the present invention without departing from the spirit and scope of the invention as defined in the claims.

What is claimed is:

1. A method for producing carbon nanostructures comprising:
chemical vapor deposition, in a thermal environment, using a carbon source and a mixture catalyst, the mixture catalyst comprising at least one element, from a group A including Fe, Co and Ni, and at least one supporting element, from a group B including lanthanides.

2. The method for producing carbon nanostructures according to claim 1, wherein the Fe, Co and Ni are in their metallic, oxide, or alloy form.

3. The method for producing carbon nanostructures according to claim 1, wherein the lanthanides include Ce, Pr, Nd, Sm, Eu, Gd, Tb, Dy, Ho, Er, Tm, Yb, and Lu.

4. The method for producing carbon nanostructures according to claim 1, wherein the lanthanides are in an oxide or alloy form.

5. The method for producing carbon nanostructures according to claim 1, wherein group A further includes Group VI-VIII metals.

6. The method for producing carbon nanostructures according to claim 1, wherein group A further includes Ru, Rh, Pd, Os, Ir, Pt, and mixtures thereof.

7. The method for producing carbon nanostructures according to claim 1, wherein group B further includes Sc, Y, and La.

8. The method for producing carbon nanostructures according to claim 1, wherein the catalyst is either in a pure form or supported on MgO or y-alumina.

9. The method for producing carbon nanostructures according to claim 1, wherein an atomic ratio of group A to group B is in a range of 1:1000 to 1:1.

10. The method for producing carbon nanostructures according to claim 1, wherein an atomic ratio of group A to group B is in a range of 1:100 to 1:1.

11. The method for producing carbon nanostructures according to claim 1, wherein element particle sizes of group A and/or group B are 10 micrometers or less.

12. The method for producing carbon nanostructures according to claim 1, wherein element particle sizes of group A and/or group B are 100 nm or less.

13. The method for producing carbon nanostructures according to claim 1, wherein element particle sizes of group A and/or group B are 10 nm or less.

14. The method for producing carbon nanostructures according to claim 1, further comprising placing the mixture catalyst into the thermal environment before chemical vapor deposition.

15. The method for producing carbon nanostructures according to claim 1, further comprising introducing the mixture catalyst into the thermal environment as a pressurized spray during chemical vapor deposition.

16. The method for producing carbon nanostructures according to claim 1, further comprising grinding the mixture catalyst using ball-milling prior to chemical vapor deposition.

17. The method for producing carbon nanostructures according to claim 1, wherein the carbon source includes a hydrocarbon with a general formula CnHm, where n is in a range of 1 to 8 and m is in a range of 2 to 20.

18. The method for producing carbon nanostructures according to claim 1, wherein a temperature of the thermal environment is fixed to a temperature in a range of 400° C. to 1200° C.

19. The method for producing carbon nanostructures according to claim 1, wherein a temperature of the thermal environment is fixed to a temperature in a range of 400° C. to 800° C.

20. The method for producing carbon nanostructures according to claim 1, wherein a temperature of the thermal environment is fixed to a temperature in a range of 600° C. to 1000° C.

21. The method for producing carbon nanostructures according to claim 1, further comprising increasing the temperature of the thermal environment during chemical vapor deposition.

22. The method for producing carbon nanostructures according to claim 21, wherein the temperature of the thermal environment is increased at a rate in a range of 0.1° C. to 20° C. per minute during chemical vapor deposition.

23. The method for producing carbon nanostructures according to claim 21, wherein the temperature of the thermal environment increases at a rate in a range of 0.1° C. to 5° C. per minute during chemical vapor deposition.

24. An apparatus for producing carbon nanostructures comprising:
a thermal reactor operable to create a thermal environment conducive to chemical vapor deposition;
a carbon source supplier for supplying a carbon source, used in the chemical vapor deposition, into the thermal reactor; and
a catalyst supplier for supplying a catalyst into the thermal reactor which, when combined with the carbon source and reacted during the chemical vapor deposition, produces carbon nanostructures.

25. The apparatus for producing carbon nanostructures according to claim 24, wherein the catalyst supplier is operable to supply the catalyst into the thermal reactor by gas flowing.

26. The apparatus for producing carbon nanostructures according to claim 24, wherein the catalyst supplier is operable to pressurize the catalyst before the catalyst is supplied into the thermal reactor.
